(19) United States
(12) Patent Application Publication
(10) Pub. No.: US 2022/0248117 A1
(43) Pub. Date: Aug. 4, 2022

(54) LOW PROFILE ACOUSTIC CHAMBERS FOR HEADSET AUDIO SYSTEMS

(71) Applicant: Kingston Technology Corporation, Fountain Valley, CA (US)

(72) Inventors: Chia-Ming Chang, Taichung City (TW); Wei-Min Liang, Hsinchu City (TW)

(21) Appl. No.: 17/166,579

(22) Filed: Feb. 3, 2021

(51) Int. Cl. H04R 1/10

(52) U.S. Cl. CPC H04R 1/1008; H04R 1/1075; H04R 2201/029; H04R 2460/11; H04R 1/1083

(57) ABSTRACT

This application discloses and describes a variety of systems, methods, and devices directed to headset audio systems having acoustic chambers. Acoustic chambers of the inventive subject matter can be implemented such that the backside of a speaker diaphragm projects sound waves into an acoustic chamber. Because acoustic chambers are formed to create fixed volumes of space, this minimizes impact of those sound waves projected from the back of a speaker diaphragm that could otherwise affect sound reproduction. This new inventive audio system actually differentiates from the way diaphragms are attached which conventional speaker driver assembly doesn't, to accomplish the invention the way fixing magnets and other parts for magnetic delivering are invented to eliminate or integrated, such as frame or bracket is cancelled, chambers now use to fix magnetic parts.

### FIELD OF THE INVENTION

The field of the invention is headset audio systems.

### BACKGROUND

The background description includes information that may be useful in understanding the present invention. It is not an admission that any of the information provided in this application is prior art or relevant to the presently claimed invention, or that any publication specifically or implicitly referenced is prior art.

Headset audio technology has undergone near constant improvement, though there still remains room for growth as new technologies create new requirements for use of internal space. For example, wireless headsets must accommodate components like batteries and wireless communications chipsets. Because such headsets need to accommodate more than just audio equipment, earcups of such headsets are created to feature internal volumes where additional components can be housed. But frequently these types of headsets do not feature symmetrically arranged internal components, which can give rise to inconsistent sound reproduction between the two earcups of the headset. This issue must be addressed to create higher quality headsets.

One headset is described in U.S. Pat. No. 10,034,112 to Price. Price, however, fails to contemplate important innovative aspects such as the inclusion of a removable vent component. Moreover, Price fails to contemplate an acoustic chamber cover having a though hole to accommodate at least a portion of the sound driver assembly, which dramatically reduces how much volume the acoustic chamber must occupy within an earcup.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

It has yet to be appreciated that acoustic chambers can include more than just a volume of space behind a speaker. Thus, there is still a need in the art for improved, low-profile acoustic chambers that can feature venting to improve sound reproduction capabilities of headsets incorporating headset audio systems of the inventive subject matter.

### SUMMARY OF THE INVENTION

The present invention provides apparatuses, systems, and methods directed to headset audio systems having acoustic chambers. In one aspect of the inventive subject matter, a headset audio system, comprising a top cover and a bottom cover coupled with the top cover, where the top cover and the bottom cover together form an acoustic chamber that is sized and dimensioned to at least partially enclose a speaker driver assembly within the earcup. The bottom cover comprises a through hole configured to accommodate at least a portion of the speaker driver assembly, and the bottom cover comprises a venting through hole configured to receive a bottom vent.

In some embodiments, the bottom vent comprises a tubular portion, and the venting through hole can include a counterbore to, e.g., improve fit and minimize sound leakage. In some embodiments, the through hole is shaped according to the speaker driver assembly portion that it is configured to accommodate.

In another aspect of the inventive subject matter, a headset is contemplated to include two headset audio systems of the inventive subject matter. The headset comprises a left headset audio system disposed within a left earcup and a right headset audio system disposed within a right earcup. The left headset audio system comprises a left top cover and a left bottom cover coupled with the left top cover. The left top cover and the left bottom cover together form a left acoustic chamber that is sized and dimensioned to at least partially enclose a left speaker driver assembly within the left earcup. The left bottom cover has a left through hole configured to accommodate at least a portion of the left speaker driver assembly, and the left bottom cover can additionally incorporate a left venting through hole configured to receive a left bottom vent. The right headset audio system comprises a right top cover and a right bottom cover coupled with the right top cover. The right top cover and the right bottom together form a right acoustic chamber that is sized and dimensioned to at least partially enclose a right speaker driver assembly within the right earcup. The right bottom cover comprises a right through hole configured to accommodate at least a portion of the right speaker driver assembly, and the right bottom cover comprises a right venting through hole configured to receive a right bottom vent.

In some embodiments, the left bottom vent comprises a left tubular portion, and the left venting through hole can include a left counterbore. The left through hole is shaped according to the speaker driver assembly portion that it is configured to accommodate. In some embodiments, the left acoustic chamber and the right acoustic chamber create the same internal volumes of space.

One should appreciate that the disclosed subject matter provides many advantageous technical effects including removable and replaceable vent on an acoustic chamber. Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a top view of a headset audio system of the inventive subject matter.

FIG. 2 shows a bottom view thereof.

FIG. 3 shows a cutaway view thereof.

FIG. 4 shows a bottom view of a top cover thereof.

FIG. 5 shows a top view of a bottom cover thereof.

FIG. 6 shows a bottom view of a bottom cover thereof.

FIG. 7 shows an exploded cutaway view thereof.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Headset audio systems of the inventive subject matter comprise a speaker driver assembly (which includes, e.g., components necessary to create audio), as well as a top cover and an associated bottom cover. Embodiments of the inventive subject matter are designed to create a low-profile acoustic chamber behind a speaker diaphragm. By doing so, a consistent volume of space can be coupled with speaker driver assemblies to improve consistency of sound reproduction across multiple speaker drivers in a headset (e.g., consistency of sound reproduction between a left and right earcup). This is useful in headsets (e.g., a gaming headset), and especially high-end headsets where accurate and consistent sound reproduction across both earcups is important to create a high-end product.

Embodiments of the inventive subject matter are intended to create such an acoustic chamber while also minimizing how much space the resulting headset audio system occupies. This leaves room within an earcup incorporating a headset audio system of the inventive subject matter for other electronic components (e.g., batteries, wireless modules, etc.). Thus, embodiments disclosed in this application are directed to low-profile (e.g., low thickness) headset audio systems that feature improved consistency of sound reproduction by incorporating fixed-volume acoustic chambers behind each speaker diaphragm.

As mentioned above, headset audio systems of the inventive subject matter can be incorporated into headset earcups. Incorporation into different earcups does not require any special steps or features, and thus although this application describes a single headset audio system, it should be understood that with one headset audio system incorporated into one earcup, the same or similar (e.g., a mirror-image version) headset audio system can be incorporated into the opposite earcup without deviating from the inventive subject matter.

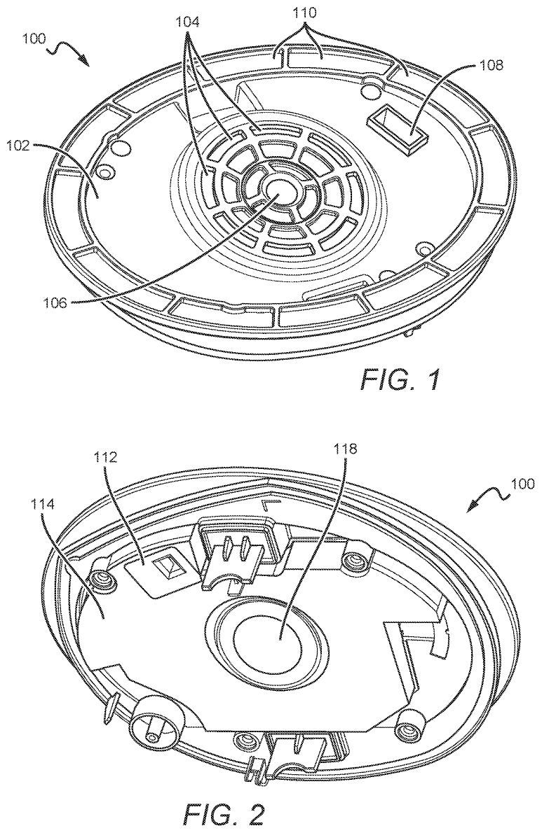

FIG. 1 shows a top perspective view of headset audio system 100. From this view, top cover 102 is visible. Top cover 102 features top vent 104 to allow sound generated by a speaker driver assembly to travel from speaker diaphragm 106 out into ambient air. Top cover 100 additionally includes top vent 108, which connects ambient air to an acoustic chamber. Edge features 110 (with the reference numeral pointing to some, but not all, of these features, which can span the entire edge of the headset audio system as shown in FIG. 1) can be used to facilitate coupling external features such as earcup cushions. Each edge feature 110 can comprise an adhesive to facilitate coupling external features or components.

FIG. 2 shows a bottom perspective view of headset audio system 100. From this view, bottom vent 112 is shown coupled with bottom cover 114. Bottom vent 112 is configured to fit into a through hole in bottom cover 114 , and it is contemplated that bottom vent 112 can take on a variety of different configurations. For example, in some embodiments, an air pathway through bottom vent 112 can be large or small. Cross-sectional area is not limited to any particular value or range, and instead can be described relative to associated components. For example, cross-sectional area of an air pathway through bottom vent 112 can range from nearly closed to half of the speaker diaphragm's area (or, e.g., 75% of speaker diaphragm area), and the air pathway itself can additionally include different shapes, such as circle, oval, rounded rectangular, etc. It is contemplated that different shapes and cross-sectional areas can be incorporated into a single bottom vent. In some embodiments, bottom vent 112 is configured to vent to the interior of an earcup (external covering not shown), while in other embodiments, bottom vent 112 can be configured to vent to the earcup's exterior.

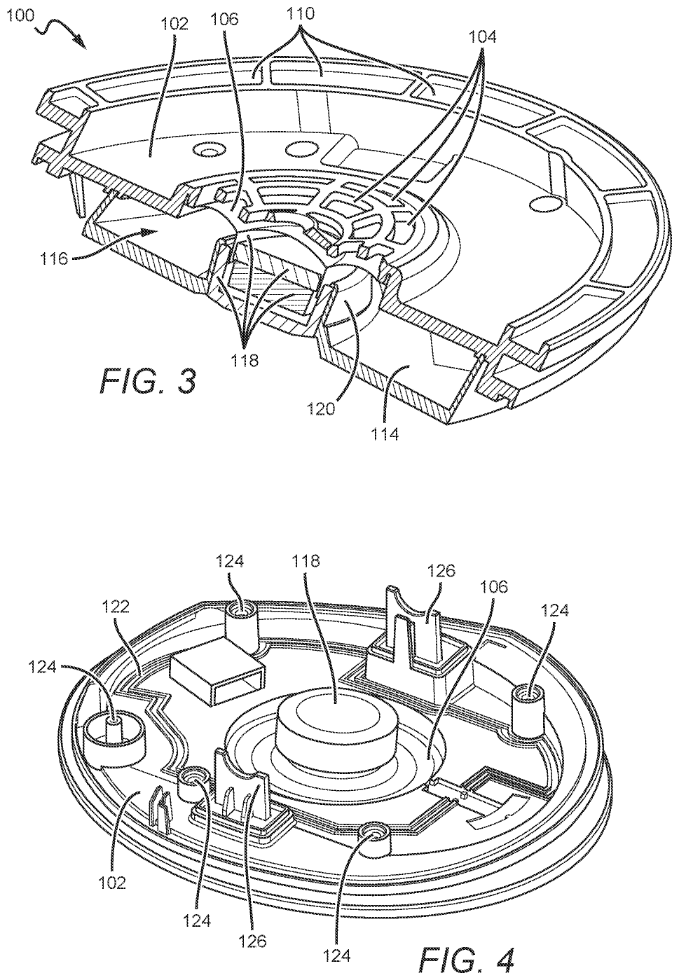

Coupled together, top cover 102 and bottom cover 114 form an interior space that acts as an acoustic chamber. Acoustic chambers of the inventive subject matter can create a range of volumetric spaces. For example, acoustic chamber volumes can vary to fit different speaker designs. For example, the lower the first resonant frequency of a particular speaker assembly, the smaller the associated acoustic chamber volume can be. Volume can be any size as long as the headset audio system still fits within a headset's earcup. FIG. 3 is a cutaway view showing acoustic chamber 116 as well as speaker driver assembly 118. Speaker driver assembly 118 thus mounts into a through hole with an extruded lip (referred to hereinafter as mounting feature 120). Speaker diaphragm 106 couples with top cover 102 around its outer edges and it couples (e.g., directly couples or indirectly couples with an air gap) with speaker driver assembly 118 nearer its center.

FIG. 4 shows the interior side of top cover 102 with bottom cover 114 decoupled therefrom. From this view, the interior side of speaker diaphragm 106 is visible and the speaker driver assembly 118 protrudes away from the diaphragm. A trough 122 with protruding lips is disposed on the interior side of top cover 102. Trough 122 exists to facilitate coupling with bottom cover 114, as trough 122′s shape matches the edges of bottom cover 114 that come into contact with top cover 102. The protruded edges of trough 122 rest on either side of the edges of bottom cover 114 to prevent bottom cover 114 from being accidentally displaced and make it easier to properly couple bottom cover 114 with top cover 102 with both components properly positioned relative to one another.

Other features shown in FIG. 4 include various coupling elements 124 that facilitate coupling headset audio system 100 with an earcup by, e.g., dowel, screw, pressure fit, adhesive, etc.

Other coupling features 126 also protrude away from the interior side of top cover 102; these other coupling features 126 are designed to interact with features in an earcup to ensure, e.g., proper alignment between components.

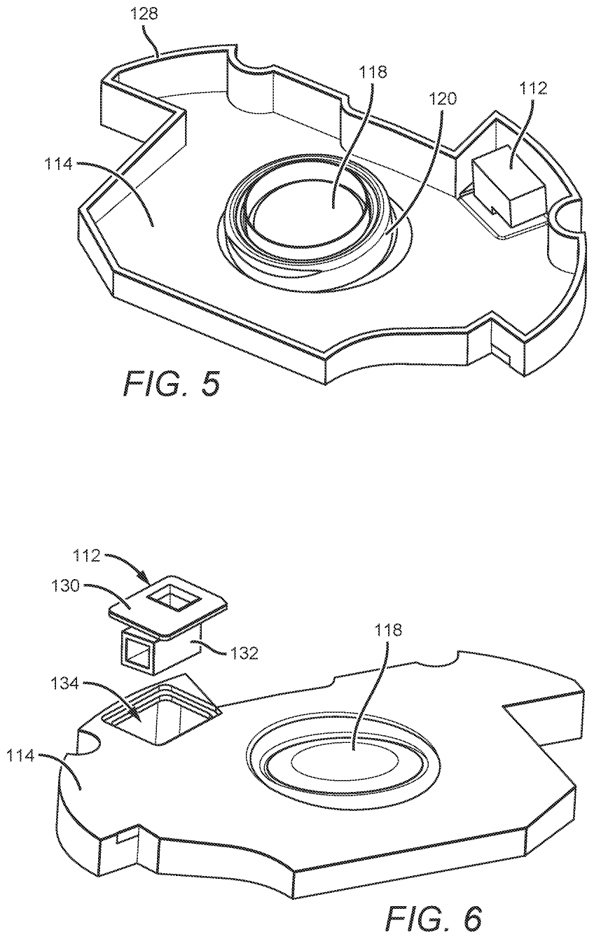

FIG. 5 shows the interior side of bottom cover 114 with the top cover 102 and speaker diaphragm hidden from view. Remaining portions of speaker driver assembly 118 are visible. Bottom cover 114 is shaped like a tray having outer edges 128 that extend away from a main surface (e.g., the flat surface that reference number 114 points to). This view shows mounting feature 120 with speaker driver assembly 118 mounted therein, and it also shows bottom vent 112 coupled to bottom cover 114

As shown in FIG. 6, which shows an exploded view of bottom cover 114, bottom vent 112 includes a flared portion 130 and a vent portion 132 that runs through the bottom vent 112. With bottom vent 112 exploded away from bottom cover 114, through hole 134 that is sized and dimensioned to facilitate coupling bottom vent 112 with bottom cover 114 is visible.

Through hole 134 is shown as being counterbored (or, e.g., countersunk in some embodiments), creating an inset area that flared portion 130 of bottom vent 112 can fit into without passing through. In some embodiments, counterbore depth is greater than or equal to the flare portion's thickness such that flared portion 130 is flush with the outer surface of bottom cover 114. Bottom vent 112 can be coupled with bottom cover 114 by, e.g., pressure fit, adhesive, or the like.

Vent portion 132 comprises a tubular structure having a rectangular (e.g., square) cross-sectional shape with a right angle incorporated therein, and the tubular portion extends from flared portion 130 into acoustic chamber 116. In some embodiments, the bend in vent portion 132 can be angled differently from 90 degrees (e.g., greater than or less than 90 degrees by up to +/−45 degrees), and in some embodiments it can include a curved portion. The bend in vent portion 132 can, e.g., improve performance by causing sound waves to vent indirectly from acoustic chamber 116 into other portions of an earcup implementing a headset audio system of the inventive subject matter. This can reduce the amplitude of reflected sounds re-entering the acoustic chamber, thereby reducing interference and improving sound reproduction consistency between different headset audio systems. Specifically, embodiments of the inventive subject matter can be implemented to bring about better sound reproduction between a left and right earcup in a headset even when the left and right earcups might house different components and have otherwise different internal configurations. By incorporating consistent acoustic chambers, the functional volume and configuration of space behind each speaker's diaphragm can be made the same.

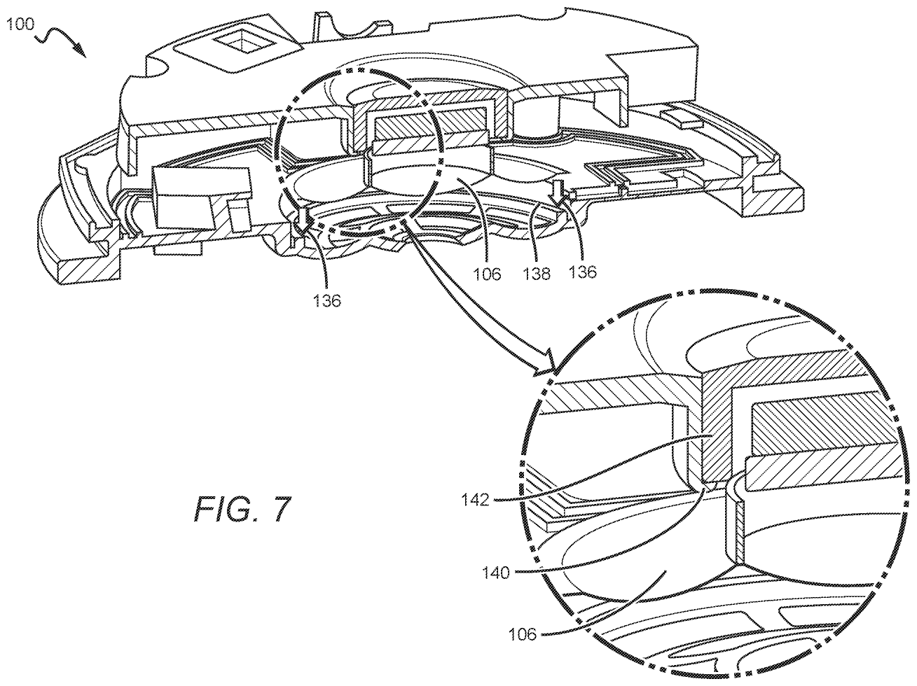

Systems of the inventive subject matter additionally facilitate headset audio system assembly in a new way. FIG. 7 shows an exploded cutaway view of headset audio system 100, which shows how speaker diaphragm 106 couples with top cover 102. Unlike ordinary headset audio systems, speaker diaphragm 106 mates with top cover 102 on the interior side of top cover 102, whereas the current state of the art involves speaker diaphragm coupling with a frame from the top side. FIG. 7 includes arrows 136 that show how speaker diaphragm 106 couples with top cover 102. Speaker diaphragm's outer edge contacts the interior side of top cover 106 along a lip 138. Some embodiments are notable for not requiring or using any additional bracing or framing on the interior side of the diaphragm (e.g., the side of the diaphragm facing the speaker driver assembly) where that additional bracing or framing would contact the interior side of the edges of the diaphragm to provide structural support while allowing the diaphragm to move.

A zoomed in view of a portion of the headset audio system is also included in FIG. 7. This view shows mounting feature 120, which includes a mounting lip 140. Mounting lip 140 exists such that speaker assembly end cap 142 fits within mounting feature 120 and is prevented from passing through mounting feature 120 by mounting lip 140. Mounting lip 140 helps to keep speaker driver assembly 118 in place in headset audio system 100 by giving speaker driver assembly 118 a feature to press against, preventing speaker driver assembly 118 from moving or otherwise being dislodged when its electromagnet is activated to create sound by moving the diaphragm.

In effect, this results in the speaker driver assembly 118 being assembled from both sides of bottom cover 114, with at least speaker diaphragm 106 coupling with the speaker driver assembly 118 from the interior side of bottom cover 114, and where at least end cap 142 mates with mounting feature 120 from exterior side of bottom cover 114 so that it pushes up against mounting lip 140 while seated within mounting feature 120. Moreover, because speaker diaphragm 106 couples with an interior side of top cover 102, there is no need for internal structural elements to hold the outer edges of diaphragm 106 in place, and with those structural elements eliminated, the resulting acoustic chamber is larger despite the headset audio system being smaller overall.

Thus, specific systems, devices, and methods directed to headset audio systems are disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A headset audio system, comprising:
a top cover;
a bottom cover coupled with the top cover;
wherein the top cover and the bottom cover together form an acoustic chamber that is sized and dimensioned to at least partially enclose a speaker driver assembly within the acoustic chamber;
wherein the bottom cover comprises a through hole configured to accommodate at least a portion of the speaker driver assembly; and
wherein the bottom cover comprises a venting through hole configured to receive a bottom vent, the bottom vent comprising a tubular portion.

2. The headset audio system of claim 1, wherein the tubular portion comprises a bend.

3. The headset audio system of claim 1, wherein the venting through hole comprises a counterbore.

4. The headset audio system of claim 1, wherein the through hole is shaped according to at least a portion of the speaker driver assembly.

5. The headset audio system of claim 1, further comprising a diaphragm, wherein the diaphragm contacts an interior side of the top cover.

6. A headset, comprising:
a left headset audio system disposed within a left earcup, the left headset audio system comprising:
a left top cover;
a left bottom cover coupled with the left top cover;
wherein the left top cover and the left bottom cover together form a left acoustic chamber that is sized and dimensioned to at least partially enclose a left speaker driver assembly within the left earcup;
wherein the left bottom cover comprises a left through hole configured to accommodate at least a portion of the left speaker driver assembly; and
wherein the left bottom cover comprises a left venting through hole configured to receive a left bottom vent, the left bottom vent comprising a left tubular portion;
a right headset audio system disposed within a right earcup, the right headset audio system comprising:
a right top cover;
a right bottom cover coupled with the right top cover;
wherein the right top cover and the right bottom together form a right acoustic chamber that is sized and dimensioned to at least partially enclose a right speaker driver assembly within the right earcup;
wherein the right bottom cover comprises a right through hole configured to accommodate at least a portion of the right speaker driver assembly; and
wherein the right bottom cover comprises a right venting through hole configured to receive a right bottom vent, the right bottom vent comprising a right tubular portion.

7. The headset of claim 6, wherein the left tubular portion comprises a left bend.

8. The headset of claim 6, wherein the left venting through hole comprises a left counterbore.

9. The headset of claim 6, wherein the left through hole is shaped according to at least a portion of the left speaker driver assembly portion.

10. The headset of claim 6, wherein the right tubular portion comprises a right bend.

11. The headset of claim 6, wherein the right venting through hole comprises a right counterbore.

12. The headset of claim 6, wherein the right through hole is shaped according to at least a portion of the right speaker driver assembly portion.

13. The headset of claim 6, wherein the left acoustic chamber and the right acoustic chamber create the same internal volumes of space.

14. The headset of claim 6, further comprising a left diaphragm and a right diaphragm, wherein the left diaphragm contacts an interior side of the left top cover and the right diaphragm contacts an interior side of the right top cover.
